(19) United States
(12) Patent Application Publication
(10) Pub. No.: US 2012/0068070 A1
(43) Pub. Date: Mar. 22, 2012

(54) PYROELECTRIC MATERIAL, RADIATION SENSOR, METHOD OF MAKING A RADIATION SENSOR, USE OF LITHIUM TANTALATE AND LITHIUM NiOBATE

(75) Inventors: Fred Plotz, Taunusstein (DE); Gerhard Knaup, Einhausen (DE); Henrik Ernst, Katzenelnbogen (DE)

(73) Assignee: EXCELITAS TECHNOLOGIES GMBH & CO. KG, Wiesbaden (DE)

(21) Appl. No.: 13/256,897

(22) PCT Filed: Jan. 7, 2010
(86) PCT No.: PCT/EP2010/000043

§ 371 Date: Nov. 29, 2011

(30) Foreign Application Priority Data
Mar. 16, 2009 (DE) 10 2009 013 336.4

(51) Int. Cl. G01J 5/10; C01D 15/02; H01M 6/00; H01B 1/08

(52) U.S. Cl. 250/338.3; 252/518.1; 423/594.8; 29/623.1

(57) ABSTRACT

A pyroelectric material is made of lithium tantalate treated to an extent that a bulk resistivity is in a range of less than 2e+14Ω*cm, preferably less than 5e+12Ω*cm, but more than a lower threshold is obtained.

### BACKGROUND

1. Field

The aspects of the disclosed embodiments relate to a pyroelectric material, to a radiation sensor, to a method of making a radiation sensor and to a use of lithium tantalate and lithium niobate.

2. Brief Description of Related Developments

Pyroelectric materials are anisotropic materials that produce electric charges, and accordingly an electric voltage or current, upon experiencing a temperature gradient. The temperature gradient may come either from a change of temperature in the ambience or may come from radiation, particularly infrared radiation (IR) hitting the material and transforming into a temperature there. The charge/voltage/current produced by the pyroelectric material can be used for temperature change detection or direct temperature detection by using appropriate subsequent signal evaluation.

FIG. 1a shows a typical sensing element construction for a pyroelectric radiation sensing element. 10 is the pyroelectric material sensing element. It may be a flat chip-like device. The electric signal may appear between the opposing major surfaces of the chip-like device. The major surfaces may be coated partially or in full with electrically conductive material (7a, 7b) in order to electrically contact the pyroelectric material and to deplete the thermally induced charges on the surfaces of the pyroelectric material. Optionally, an absorbing layer 6 can be applied on the electrodes and/or on the pyroelectric material for enhancing absorption of the quantity to be sensed, such as IR radiation. The pyroelectric material may be shaped and manufactured into the form suitable for a sensing element. Its thickness D may be 20 μm to 500 μm, preferably 50 μm to 200 μm. Electrically, the sensing element has also properties of a capacitor.

Upon radiation incidence or change of ambient temperature, the sensing element 10 will experience a change in temperature (dT/dt≠0) and will generate in response thereto electrical charges at its opposing surfaces of the anisotropic material. These charges may be sensed as voltage from opposing terminals 4a and 4b connected to the opposing sides of the pyroelectric material sensing element 10.

Various materials for pyroelectric sensing elements 10 are known. Some of them have lead as main constituent. Besides various other disadvantages, these materials are not in compliance with EU's ROHS guideline and are insofar disadvantageous. Besides, they have a low Curie temperature so that their pyroelectric properties are endangered by temperatures possibly reached during soldering, general handling and high temperature operation.

Lithium tantalate (“LiTa”, LiTaO₃) and lithium niobate (“LiNb”, LiNbO₃) are piezoelectric materials. They have also pyroelectric properties. But for reasons explained below, these pyroelectric properties are not exploited, but are rather considered a noise source in the actually desired piezoelectric applications. LiTa and LiNb are compliant with ROHS, but have in their pyroelectric properties a significant disadvantage as regards their electrical signal output characteristics especially under the influence of changing ambient temperature. This will explained with reference to FIG. 2.

FIG. 2 shows a typical curve of temperature over time T(t) as curve 21. Temperature change may come either from a primary signal to be detected, e. g. in motion detection from a person passing by a sensor (duration some seconds), or may come from distortions/noise such as change of ambient temperature, e.g. day to night ambient temperature change or direct sunlight exposure or proximity to heating or cooling devices (duration between seconds up to several hours). Curve 22, 23 shows a related output signal of conventional LiTa or LiNb under the influence of non-radiation induced ambient temperature changes. Typically, the output signal increases as temperature changes and decreases when temperature becomes constant. Insofar, the main electrical signal corresponds more or less to temperature change over time dT/dt (derivative of T over time). The pyroelectric coefficients of LiTa and LiNb are relatively high so that from a primary point of view the materials would be suitable for pyroelectric detectors. Besides that, they have a high Curie temperature of around 602° C.

However, besides the described main output signal, LiTa and LiNbO₃ show also spark discharge, exemplified by peaks 23 in the electrical characteristics, particularly when the ambient temperature changes. These sparks come from charges accumulating at the surface of the pyroelectric material over temperature changes to the entire sensor and discharges on a statistical basis based on unpredictable surface effects. LiTa has a very high bulk resistivity of more than 4e+14[Omega]cm. Due to this high bulk resistivity, charges accumulate locally at the spot where they were generated. Depending on local inhomogeneities and local insulation properties, the accumulated charges will lead to relatively high local voltages which may discharge in the form of little sparks, as referenced by 23 in FIG. 2. Such sparks have strong influence on the quality of the output signal. They make the output signal unpredictable and worsen the signal-noise (S/N) ratio thereof. For this reason (i.e. the high bulk resistivity), conventional LiTa is practically not widely used as pyroelectric material. As said above, LiTa is well known for piezoelectric applications. For actuator applications, the pyroelectric properties of LiTa are not really relevant because they are small and weak in effect compared to driving signals for piezo actuators. For sensor applications, however, the pyroelectric properties of LiTa constitute a problem because the desired piezoelectric signal has a pyroelectric signal component superimposed when temperature changes. Thus, particularly when LiTa is desired to be used as piezoelectric sensor element, there is a strong desire to avoid or reduce the pyroelectric properties of LiTa. This applies both to the spark discharge characteristics 23 and to the primary pyroelectric signal 22. The paper “Black-LT Black-LN” by YAMAJU CERAMICS CO., LTD describes so called “Black LT” (where “LT” stands for lithium tantalate) and “Black-LN” (where “LN” stands for lithium niobate). In these substances measures were taken for suppressing the pyroelectric properties of these materials for avoiding signal components caused by thermal gradients over time superimposed on the piezoelectrically generated signal component. Basically, the black LT material has reduced bulk resistivity of e.g. 2.3e+11Ω cm or 2.1e+10Ω*cm, compared to the usual 4.5e+14Ω cm.

EP 1741809A1 describes an electrostatic charge controlling process for piezoelectric oxide single crystal and an apparatus for electrostatic charge controlling process. A lithium tantalate single crystal and a reducing agent are accommodated in a processing tank for reducing the wafer material.

U.S. Pat. No. 7,323,050 discloses a method of producing lithium tantalate crystal. A first material containing lithium tantalate subjected to a heat treatment at a temperature of at least the Curie temperature in a reducing atmosphere is superimposed on a single- Polarized lithium tantalate crystal, and then the crystal is subjected to a heat treatment at a temperature that is lower than Curie temperature in a reducing atmosphere.

### SUMMARY

One aspect of the disclosed embodiments includes a material for pyroelectric applications, a pyroelectric sensor, a method of making a radiation sensor and a use of lithium tantalate or lithium niobate allowing the sensing of radiation with reasonable sensitivity and signal to noise ratio while being ROHS compliant and having a relatively high Curie temperature. A pyroelectric material comprises lithium tantalate or lithium niobate treated or modified such that a bulk resistivity of the material is less than a certain first threshold and preferably above another lower second threshold. The treatment or modification may be a chemical reduction step or a crystal grid modification step or a mixing step.

The bulk resistivity is a material property, sometimes called “specific resistance” and symbolized by the Greek letter ρ (rho). Its dimension is Ohm*meters (Ω*m, Ω m), but may of course also be expressed by Ohm*centimetres (Ω*cm, Ω cm).

Aspects of the disclosed embodiments are also the use of modified lithium tantalate or modified lithium niobate for pyroelectric detection, i.e. for detection of heat radiation (such as IR radiation). Other aspects are a pyroelectric sensor having said pyroelectric material and a method of making such a pyroelectric sensor.

### BRIEF DESCRIPTION OF THE DRAWINGS

In the following, embodiments of the disclosure and aspects thereof are described with reference to the drawings in which

FIG. 1 shows various sectional views of a radiation sensing element and mounting possibilities thereof,

FIG. 2 shows characteristics of conventional lithium tantalate and of modified lithium tantalate,

FIG. 3 shows characteristics over bulk resistivity, and

FIG. 4 schematically a sensor.

### DETAILED DESCRIPTION OF THE DISCLOSED EMBODIMENTS

In this specification, same reference numerals shall denote same features. Features shall be deemed combinable with each other also if this is not explicitly said, as far as a combination of the features is not excluded for technical reasons. Device features shall be considered to be also a disclosure for a manufacturing step for attaining said features, just as vice versa manufacturing steps shall be considered to be a disclosure also for respectively attained device features. A pyroelectric material comprises lithium tantalate or lithium niobate treated or modified such that a bulk resistivity of the material of less than 2e+14Ω*cm (=2*10¹⁴ Ohm*centimetre), preferably less than 2e+13Ω*cm, more preferably less than 5e+12Ω*cm is reached. Preferably, the bulk resistivity is above 2e+10Ω*cm, preferably above 1e+11Ω cm, more preferably above 3e+11Ω*cm, more preferably above 1e+12Ω*cm.

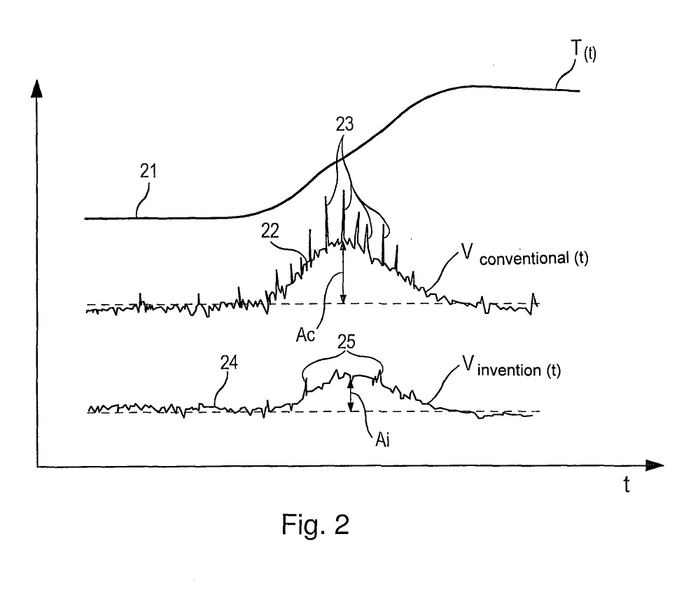

The reduction of the bulk resistivity to a value less than the mentioned upper thresholds serves to add some conductivity to the material so that charges have a reduced tendency of locally accumulating so that sparks (23) as shown in FIG. 2 are suppressed. Generally speaking, the lower the bulk resistivity is, the lower is the generation of sparks. However, at the same time also the primary signal degrades for the simple reason that it is shorted to some extend by the relatively low material resistance caused by the lowered bulk resistivity. In order to have a material that still reasonably operates as a pyroelectric material, the treatment or modification is made such that the bulk resistivity remains above one of the mentioned lower thresholds. Through this, the material shows enough primary signal amplitude Ai (corresponding to the curve 24 in FIG. 2).

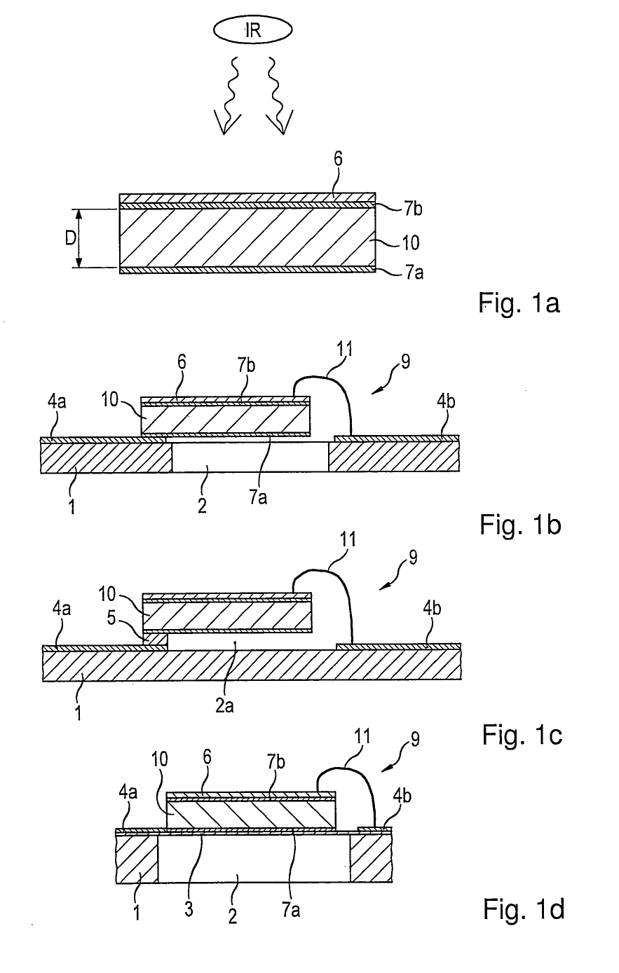

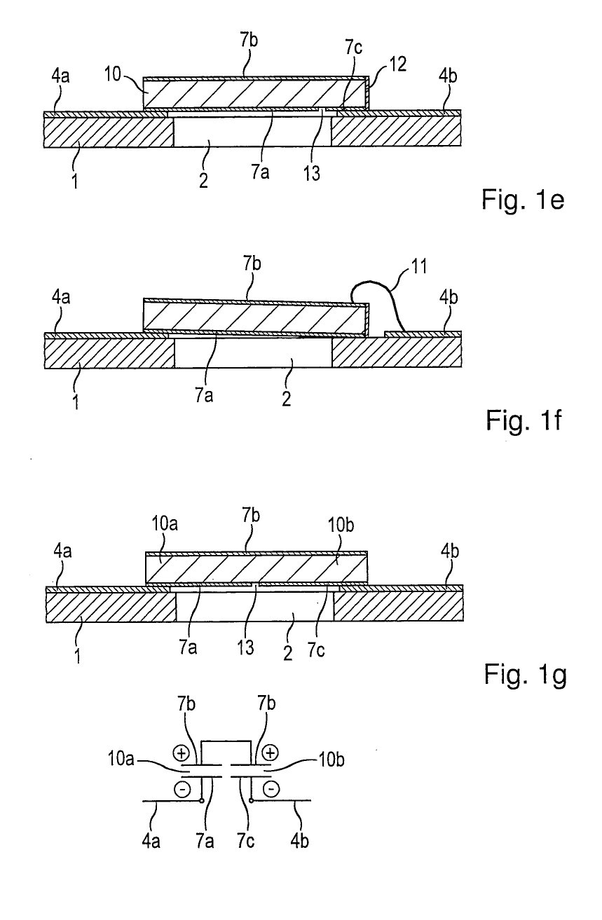

The construction of the sensing element may be as shown in FIG. 1a and described with reference thereto. The contacts 7a, 7b may be thin layers of metal, e.g. vapour deposited gold. An absorber layer 6 may be provided. It may have a cutout for contacting the contact layer 7b. In this shape, in a manufacturing method, the sensing element 10 may be pre-manufactured. In FIG. 2, curve 24, 25 shows the electrical characteristics of lithium tantalate treated or modified as described above. Due to the decreased bulk resistivity, the signal output amplitude Ai of the main signal 24 may be lower than that Ac of the conventional lithium tantalate. However, also the occurrence of sparks, as referenced by 25, is significantly reduced, usually both in frequency of occurrence and in amplitude. Such a characteristic is, despite its lowered main signal amplitude or strength, much better suited for radiation detection than conventional, untreated lithium tantalate.

The relatively high Curie temperature is desirable because this temperature determines the temperature limit above which the material irreversibly degrades in its sensitivity because its anisotropy gets lost. High temperatures of circuit elements may particularly be reached during soldering. This is particularly the case when using SMT (Surface Mounting Technology) and SMD (Surface Mounted Devices), where the heat from soldering almost immediately enters into the sensing components. For avoiding temperature damage, a high Curie temperature is desired, which criterion is met both by conventional and by modified LiTa and LiNb.

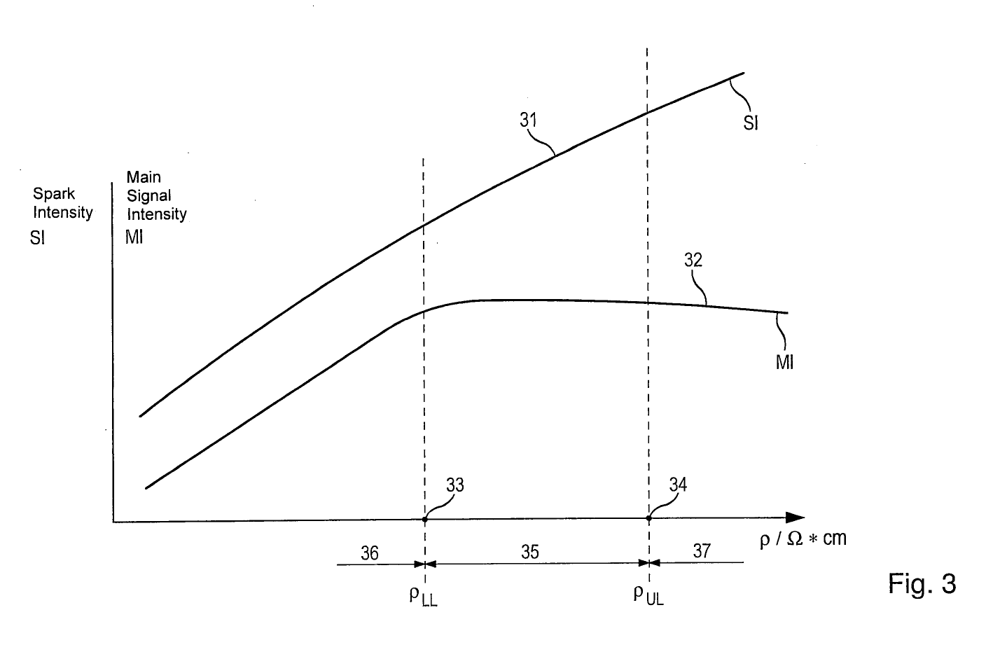

FIG. 3 shows qualitatively the considerations behind the given thresholds. The abscissa is the bulk resistivity in Ω cm, increasing from left to right. 35 is a range of bulk resistivity that is most preferably used for pyroelectric materials, whereas most preferably ranges 36 left of range 35 (i.e. of lower bulk resistivity) and range 37 right of range of range 35 (i.e. of higher bulk resistivity) are not used.

Curve 31 represents qualitatively the spark intensity SI, which may be one or more of statistical frequency of occurrence, amplitude, energy or the like. Curve 32 is a measure for the primary signal amplitude MI on which the sparks are superimposed. As explained above, the spark intensity as shown in curve 31 increases with increasing bulk resistivity because charges accumulate locally and lead to spark discharge. This disturbing effect is reduced by reducing the bulk resistivity to values that have reasonably reduced spark intensities. In FIG. 3, value 34 on the abscissa denotes such an upper threshold for the bulk resistivity. From there toward the left side of the diagram, the spark intensity decreases continuously, and under this aspect alone a bulk resistivity as low as possible would be desired.

However, the bulk resistivity influences not only the spark intensity but also the main signal amplitude, as gualitatively shown by curve 32. A decreasing bulk resistivity (corresponding to increasing bulk conductivity) leads actually to equalizing not only charges leading to spark discharge but also to equalizing or short circuiting the main signal. Under this aspect, a bulk resistivity as high as possible is desired, it must remain above a certain threshold for giving reasonable main signal output. Such a lower threshold of the bulk resistivity is shown as value 33 on the abscissa. Left of it, the bulk resistivity is so low that the main signal is significantly short circuited so that the absolute value of the main signal output becomes unsatisfactory. Right of value 33, the main signal output becomes reasonable, and under this aspect a bulk resistivity as high as possible would be desired.

Besides the above considerations, a material, for being suitable for pyroelectric sensing, must both have a sufficiently strong main output signal, as represented by curve 32, and it must have a sufficiently high S/N ratio which is a relative value between main signal quantity represented by curve 32 and noise quantities, e. g. spark discharge, as represented by curve 31. It is not a matter of course that under the above mentioned criteria of suppressing spark intensity and maintaining the main signal both on a reasonable level and a reasonable S/N ratio a valuable range can be found for modifying LiTa. However, the examinations of the inventors under the above described considerations show that reasonable ranges of the bulk resistivity exist so that the material can be used as pyroelectric material, provided the desired bulk resistivities can be adjusted.

Untreated lithium tantalate can be treated such that satisfactory spark suppression, a satisfactory main signal and a satisfactory S/N ration can be obtained, or, in other words, that the lower threshold 33 is lower than the upper threshold 34 so that range 35, confined by the thresholds, opens. As said above, the upper threshold value 34 may be 2e+14Ω*cm or 2e+13Ω*cm or 5e+12Ω*cm. The lower threshold value 33 may be 2e+10Ω*cm or 1e+11Ω cm or 3e+11Ω*cm or 1e+12Ω*cm.

The lithium tantalate material according to one embodiment is preferably a single crystal, but may also be a poly-crystalline body. It may be a comparatively thin layer electrically connected on its opposing sides or surfaces, seen in the direction of its pyroelectric anisotropy. It may also be manufactured as a separate self-supporting device, having electrical contacts at opposing sides thereof.

FIGS. 1b to 1g show mounting possibilities. The sensing elements 10 is preferably self-supporting and held such that only small portions thereof (less than 20% of the area, preferably less than 10%) are in contact with thermal masses other than ambient gas. The sensing elements 10 may be shaped as shown in FIG. 1a, unless described differently below.

As shown in FIG. 1b, the sensing element 10 may only at its one edge or corner be attached to a substrate 1. The attachment may also constitute an electrical connection. The substrate may be a circuit board with wiring 4a, 4b thereon. The main portion of the sensing element 10 is above a cutout 2 of the substrate. So, the element 10 is thermally isolated from thermal masses other than ambient gas/air so that the incident IR radiation is better transformed into a temperature change of the sensing element 10 itself. The other electrical connection (top surface) may be a bonding connection 11.

In FIG. 1c, the sensing element 10 is held above the substrate 1, e.g. by a distance keeping part 5 that may be conductive and thus also provides the electrical connection. Likewise, the sensing element 10 may be held on a thin membrane 3 held by a frame 1 having a cutout 2, as shown in FIG. 1d.

As said, one of the electrical connections of the sensing element 10 to the substrate 1 (left hand side in FIG. 1b, 1c) may also provide for the mechanical connection and may thus have a double function.

In FIG. 1e, the sensing element is supported at both opposing edges by the substrate. The not-shown edges of a rectangular-shaped sensing element (above and below the drawing plane) may or may not be supported by the substrate. The lower surface metallization 7a at the one edge of the cutout (left side in FIG. 1e) may sit directly on a wiring 4a on the substrate 1. At the other edge (right side in FIG. 1e), the lower surface may also have a metallized part 7c sitting on another wiring 4b. This metallized part 7c may be insulated from the other metallization 7a on the lower surface by a gap 13, but may be connected with the metallization 7b on the upper surface by a through-contact or a metallization 12 reaching around the edge of the sensing element 10. Fig. If shows another connection scheme: The opposing major surfaces may be coated partially or in full with electrically conductive material 7a, 7b. The lower surface metallization 7a at the one edge of the cutout (left side in Fig. If) may sit directly on a wiring 4a on the substrate, whereas at the other edge at least one of sensing element 10 and substrate 1 is insulated or non-conductive, while a connection, e.g. a bond connection 11, is provided from the upper surface metallization to another wiring pattern part 4b on this part of the substrate.

FIG. 1g shows yet another connection scheme and an equivalent circuit: The upper major surface may be coated partially or in full with electrically conductive material 7b. The lower surface may have two separate, preferably symmetric, metallizations 7a and 7c, e.g. separated by a minute gap similar to gap 13 in FIG. 1e, that are connected to separate wirings 4a and 4b, e. g. by sitting on them at the two edges of the cutout 2, as shown. Electrically, this renders an arrangement of two counter-parallel sensing element parts, one constituted by the first part 7a-10a-7b, the other by the second part 7b-10b-7c, as shown by the equivalent circuit. This arrangement renders a common mode rejection for signals affecting both of the counter-parallel sensing element parts, e.g. coming from ambient temperature change. The radiation to be detected must then, however, be guided such that it usually reaches the two parts asymmetrically, e.g. only one of them so that only one of them generates a signal that is not, or only partially, balanced by an opposing signal from the other part. To this end, the housing may have an imaging lens 42 or a slit aperture as radiation entrance, or one part may be shaded.

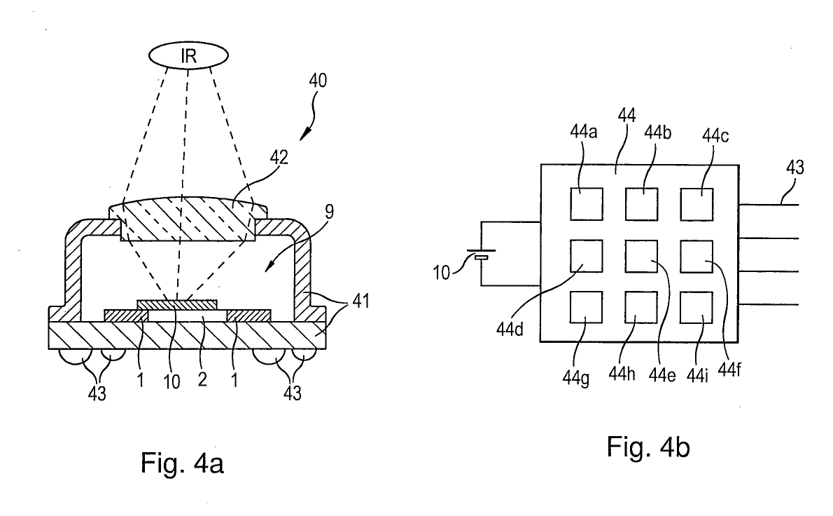

A sensor 40 for radiation detection is schematically shown in FIG. 4. It comprises one or more sensor elements 9 comprising each one or more sensing portions 10 of a pyroelectric material as described above and mounted on a thermally insulating structure 1-3 for insulating the sensing portion 10 from thermal masses (heat sinks). The sensor element 9 itself may be made as shown in FIG. 1 and may have the features described with reference thereto.

A method of making a radiation sensor 40 comprising a sensing element on a substrate comprises the steps of forming a sensing element with modified Lithium tantalate or modified lithium niobate as described above or below, particularly such that a bulk resistivity as mentioned above is attained, providing a thermally insulating substrate, placing the sensor element on the substrate and electrically connecting it. The thus formed sensor element 9 may be placed on a sensor housing base plate and connected to terminals thereof. The housing may then be closed by a pre-manufactured housing cap. The forming step may first have a modifying step for modifying bulk material (e.g. a complete wafer or larger chip or unit) to have the desired bulk resistivity, and thereafter shaping the desired sensing elements from said modified bulk material (e.g. by sawing or etching or other separation), or may first have said shaping step from bulk material and thereafter said modifying step.

The treatment may be a chemical reduction or a crystal grid modification or a mixing operation of mixing conventional LiTa with reduced or grid-modified LiTa.

An aspect of the disclosed embodiments is also the use of lithium tantalate or lithium niobate for radiation detection, particularly for pyroelectric radiation detection or for a radiation or temperature detector, wherein the lithium tantalate or lithium niobate is treated/modified as mentioned above for attaining the bulk resistivity as mentioned above and is provided as sensitive portion 10 in a sensor element 9 of a sensor.

A sensor 40 would have the sensor element 9, a housing 41 comprising, e.g., a cap and a base plate, a radiation entrance window 42 in the housing or in the cap thereof, possibly covered/closed by a radiation-transparent structure, preferably with imaging properties (lens) for focussing radiation on the sensing element 10 or on one of plural juxtaposed sensing elements for rendering spatial resolution, and terminals 43, e. g. wires extending out of the housing (base plate thereof) or plural bumps or metallized pads on an outer surface (e.g. base plate) of the sensor housing connected with the inside components for SMT in relation to a printed circuit board.

A sensor 40 may comprise in the same housing plural independently sensing pyroelectric sensor elements 9 distributed across a certain area of the sensor. Likewise, one substrate 1-3 may hold several independently sensing pyroelectric sensing portions 10 as described above. The sensor 40 may comprise, incorporated into the housing, a signal processing section 44 comprising a signal evaluation and forwarding circuit, sitting in the signal flow between the sensing portion (s) 10 and the output terminals 43 of the sensor. It may comprise one or more of signal shaping means 44a, signal filtering means 44b, time serial polling means 44c for polling/sampling plural sensing portions 10 or for plural sensor elements 9, analogue-digital conversion means 44d, ambient temperature compensation means 44e, characteristics adaptation means 44f, a writable storage 44g for characteristic values of the sensing portions, an input/output control circuit 44h for controlling output of sensed quantities, possibly in a time serial manner, and input of characteristic values. The sensor may have two, three four, five or more terminals 43.

The radiation to be sensed may be IR radiation of a wavelength of more than 1 μm or more than 2 μm. The housing may be a TO (transistor outline) housing (e.g. TO5, TO8 TO7 T041, TO46, T018, TO39, TO22) having a radiation entrance window that may be covered as described above. Lithium tantalate has the chemical formula LiTaO₃. It is a crystalline substance. The treatment for obtaining a lowered bulk resistivity may comprise a chemical reduction so that the substance under consideration may, to a higher or lower extend have molecules with less than three oxygen atoms. The treatment or modification may also be a process that changes the regular crystal grid of conventional LiTa or LiNb such that one or more oxygen atoms per molecule are displaced compared to their usual position in the regular crystal grid without completely removing said displaced oxygen atoms from the material.

Insofar, the pyroelectric material according to one embodiment may also be described as a mixture of conventional lithium tantalate (LiTaO₃) with molecules of lower oxygen content LiTaO₃₋ₓ (e.g. as LiTaO₂ or LiTaO) or with molecules having oxygen atoms displaced in comparison with their regular crystal grid position. It may still be a single crystal (layer). But it may also be a poly crystalline structure. The mixture may be such that the described bulk resistivity is obtained. The terra “treated or modified lithium tantalate” addresses a substance comprising conventional LiTa with reduced bulk resistivity, obtained e.g. by using conventional LiTa with reduced amounts of oxygen or with oxygen atoms displaced from regular grid positions, possibly in defined mixture with conventional LiTa. The crystal grid modification may be made such that essentially all molecules are modified, or only a share thereof.

The above description was given with predominant reference to lithium tantalate. Qualitatively same considerations apply with respect to lithium niobate, wherein the conventional material is LiNbO₃. A reduction or crystal grid modification may be made as described for LiTa. Compared to untreated/conventional lithium niobate, the bulk resistivity may be reduced to a value of less than 50% of the conventional material or to less than 20% or less than 10% thereof. The lower limit of the utilized range may be 1% of the value of conventional/untreated material or 3% thereof.

What is claimed is:

1. A pyroelectric material comprising lithium tantalate or lithium niobate treated to an extent that a bulk resistivity is in a range of less than 2e+14[Omega]*cm, preferably less than 5e+12[Omega]*cm.

2. The material according to claim 1 wherein the treatment is a chemical reduction or a displacement of oxygen atoms from regular positions in a crystal grid.

3. A pyroelectric material comprising a mixture of LiTaO3 and LiTaOn, wherein n is 1 or 2 and designates the number of oxygen atoms per molecule on regular crystal grid positions, while remaining oxygen atoms may be removed completely or at least away from their regular crystal grid positions, and the mixing ratio being such that a bulk resistivity is in a range of less than 2e+14[Omega]*cm, preferably less than 5e+12[Omega]*cm.

4. The material according to claim 3, wherein the bulk resistivity is more than 2e+10[Omega]*cm, preferably more than 3e+ll[Omega]*cm, preferably more than le+12[Omega]*cm.

5. The material according to claim 3, formed as a single crystal.

6. A radiation sensor comprising a sensing element on a substrate, the sensor element comprising a pyroelectric material according to claim 3.

7. The sensor according to claim 6, wherein the pyroelectric material is formed as a thin layer or thin, self supporting plate attached to the substrate.

8. The sensor according to claim 6, wherein the substrate comprises a circuit board having a cutout above which a major portion of the sensing element comes to lie.

9. The sensor according to claim 6, comprising an SMT housing with contact bumps or pads on at least one surface thereof.

10. The sensor according to claim 6, comprising a signal processing section in the housing.

11. A method of making a radiation sensor, said sensor comprising a sensor element on a substrate, the method comprising the steps of providing a substrate, forming a lithium tantalate sensing element of modified lithium tantalate material, placing the sensing element on the substrate, connecting the sensing element with wiring on the substrate, providing a housing, placing the sensor element in the housing, and connecting the wiring with terminals of the housing.

12. The method of claim 11 wherein the sensing element is pre-manufactured into a self-supporting structure.

13. Use of modified lithium tantalate for pyroelectric radiation detection.

14. Use of lithium tantalate with a bulk resistivity of less than 2e+14[Omega]*cm, preferably less than 5e+12[Omega]*cm, and of preferably more than 2e+10[Omega]*cm, preferably more than 3e+ll[Omega]*cm for pyroelectric radiation detection.

15. Use according to claim 13, wherein the used lithium tantalate was modified by a chemical reduction or by a crystal grid modification for displacing oxygen atoms from their regular crystal grid position.

16. Use according to claim 14, wherein the used lithium tantalate was modified by a chemical reduction or by a crystal grid modification for displacing oxygen atoms from their regular crystal grid position.
